(19) United States
(12) Patent Application Publication
(10) Pub. No.: US 2019/0004397 A1
(43) Pub. Date: Jan. 3, 2019

(54) Mobile Device with Tandem Lenses

(71) Applicant: DeveloperSquare, LLC, Dallas, TX (US)

(72) Inventors: Lewis Neal, Dallas, TX (US); Liam Miller, London (GB)

(21) Appl. No.: 15/705,244

(22) Filed: Sep. 14, 2017

Related U.S. Application Data
(60) Provisional application No. 62/527,788, filed on Jun. 30, 2017.

(51) Int. Cl. G03B 5/06; G03B 15/05; G03B 37/04; H04N 5/225

(52) U.S. Cl. CPC G03B 5/06; G03B 15/05; G03B 37/04; G02B 13/001; H04N 5/2256; H04N 5/2254; H04N 5/2257

(57) ABSTRACT

A system and method for a mobile device which has at least two tandem lenses. The tandem lenses work together to create a final image. The final image can be a portrait, landscape, panoramic, or a 360 degree image. At least one of the lenses is angled relative to the planar face of the mobile device. The angle controls the amount of overlap between adjacent lenses.

### PRIORITY

This application claims priority to Provisional Application No. 62/527,788 filed Jun. 30, 3017, the entirety of which is hereby incorporated by reference.

### BACKGROUND OF THE INVENTION

### Technical Field

The present invention relates to a system and method for a mobile device featuring tandem lenses.

### Description of Related Art

Due to smart phones, the camera is more available than ever before. Smart phone users expect to be able to record pictures, video, slow motion, etc. Recently, users have desired to take wide angle pictures, such as 360 degree pictures. This allows the viewer to obtain a better perspective than a prior art still photograph. However, there is a need to record a wide angle picture in a faster and more efficient way.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a front and back planar view of a mobile device with tandem lenses in one embodiment;

FIG. 2 is a left and right planar view of a mobile device with tandem lenses in one embodiment;

FIG. 3 is a top planar view of a mobile device with tandem lenses in one embodiment;

FIG. 4 is a field of view profile of a mobile device in one embodiment;

FIG. 5 depicts an image which a user sees and desires to capture;

FIG. 6 is a top view of the processing and capturing of the image in FIG. 5.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

The human eye has a field of view of around 95 degrees. The iPhone 6, made by Apple Corporation of Cupertino Calif., has a field of view of about 73 degrees, slightly less than the human eyes. Thus, a camera, or video, taken with an iPhone 6, for example, can only capture an image within the field of view of 73 degrees. Other lenses, however, have a field of view of about 172 degrees.

Today, consumers and users are desiring of capturing images and video greater than the field of view available on many common smart phones. One way of accomplishing this is to move the smart phone to allow it to capture a wider angle. As but one example, many cameras and smart phones have a panoramic function. Using this function a user holds the phone steady and slowly moves horizontally. The phone, or camera, captures a series of photographs. Thereafter, either the user or software compiles the series of images into a single panoramic image. However, this is a clunky and inefficient method to obtain a desired photograph.

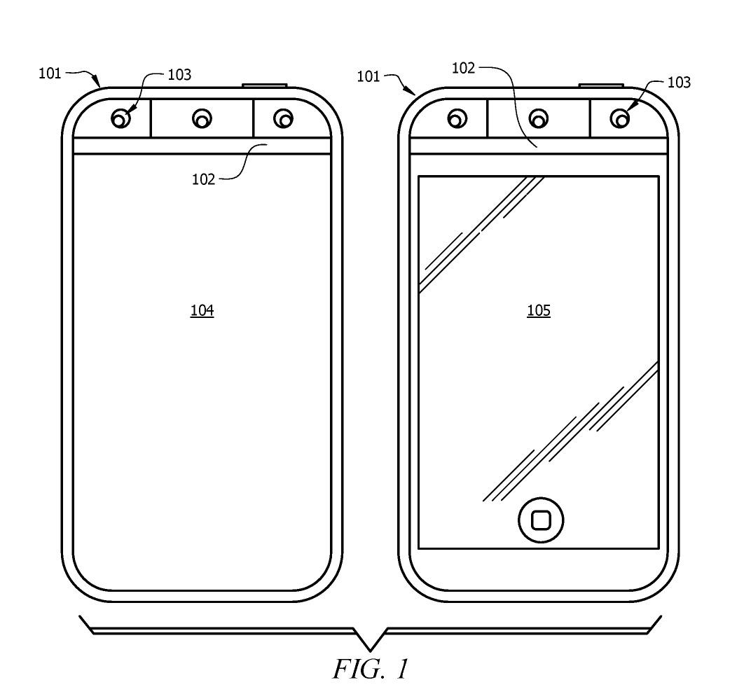

FIG. 1 is a front and back planar view of a mobile device 101 with tandem lenses 103 in one embodiment. A mobile device can comprise virtually any mobile device known in the art and can include, but is not limited to, a smart phone, a camera, a tablet, a watch, smart watch, wearable technology, smart glasses, a computer, etc. The mobile device can include any electronic device which can house a camera. While the examples below may discuss a smart phone, this is for illustrative purposes only and should not be deemed limiting.

As shown, FIG. 1 depicts a front side 104 and a back side 105. As can be seen, in one embodiment the mobile device 101 has at least one lens 103 on the front side 104 and at least one lens 103 on the back side 105. As depicted, the front side 104 has a plurality of lenses 103 and the back side 105 comprises a plurality of lenses 103. In one embodiment the lenses 103 comprise tandem lenses. Virtually any type of camera lens can be utilized. In one embodiment a sapphire lens is used. As noted, the field of view for the various lenses can be adjusted depending on the application. In one embodiment the lens comprises a field of view of approximately 172 degrees. As used herein, tandem lenses refers to at least two lenses which work together to form a wide angle picture or video. The wide angle picture can comprise a variety of angles from about 45 degrees to 360 degrees. Each of the tandem lenses 103, in one embodiment, contribute at least a portion of the final image or video. In one embodiment each tandem lens 103 contributes an equal portion to the final image. Thus, if there are four tandem lenses 103, each tandem lens 103 will contribute 25% to the final image.

Conversely, in other embodiments the tandem lenses 103 can contribute varying amounts to the final image. For example, in one embodiment the three tandem lenses 103 of the front face 104 take a photograph. Because the centered lens 103 is more centered, the software can use a higher percentage of the image taken by the center lens 103. The software will then supplement the image obtained by the center lens with the image obtained from the left and right lens 103. In this embodiment, the portion of the image obtained by the right lens 103 which overlapped the image of the center lens 103 will be discarded as the image from the center lens 103 will be used.

In still other embodiments the software will determine which image is more preferable based on a number of factors. For an example, if a portion of one of the lenses 103 is smudged, that will result in a blurry image. If the blurry image resided on an overlapped portion, then the software can opt to use the clearer image. Other factors such as clarity, color brightness, lights, and shadowing can be used to determine which content from which lens 103 will be used in the final image. It should be understood that while a still image is discussed, this is for illustrative purposes only and should not be deemed limiting. In other embodiments video, slow motion, panoramic, and other moving and still images, with and without sound, can be recorded.

As shown, the front face 104 of the mobile device 101 comprises three lenses 103. As those skilled in the art will understand, this is also for illustrative purposes only and should not be deemed limiting. The number of lenses 103 required will depend upon the size, dimension, and shape of the mobile device 101. It will also depend on the type and quality desired for the final image. As but one example, a broad and wide face such as the front face of smart phone can require more than one lens 103 per face. However, smaller and narrower devices may only require one lens 103 per face, as an example. As but one example, a mobile device can comprise the size and shape of a pencil. In such an embodiment the device can only comprise one lens 103 per face. In still other embodiments the device can only comprise a total of two opposing lenses 103.

As shown above, while one embodiment has been described wherein the mobile device comprises a smart phone, and the smart phone has lenses 103, in still other embodiments the mobile device comprises an attachment which can be coupled to a smart phone. For example, if a smart phone only has one lens, the user can obtain an attaching device, such as the devices described herein, which comprise two or more tandem lenses 103. The attaching device can capture images or video like the tandem lenses 103 discussed herein and then communicate the image or video to another mobile device, such as a smart phone. The communication can be wired or wireless. This allows consumers who do not own a smart phone with tandem lenses, for example, to still obtain the images and videos discussed herein by using an attachment which comprises tandem lenses 103. In one embodiment, and as depicted, the lenses 103 comprise an adjacent light source 102. The light source 102, in one embodiment, functions like a flash. The light source 102 can comprise a single and continuous light source, as depicted, or the light source can comprise one or more point light sources. In one embodiment a single light source can serve as the light source for two or more lenses. Thus, for example, in one embodiment a single point light source can serve as the flash for three tandem lenses 103. The light source 102 can comprise any type of light source including, but not limited to, light bulbs, LEDs, etc.

FIG. 1 also shows the back face 105. As depicted the back face 105 also comprises three tandem lenses 103. The back face 105 also comprises a light source 102. As noted, in one embodiment the light source comprises a continuous band of a light source. Thus, in one embodiment the light source 102 wraps around the entire periphery of the mobile device 101.

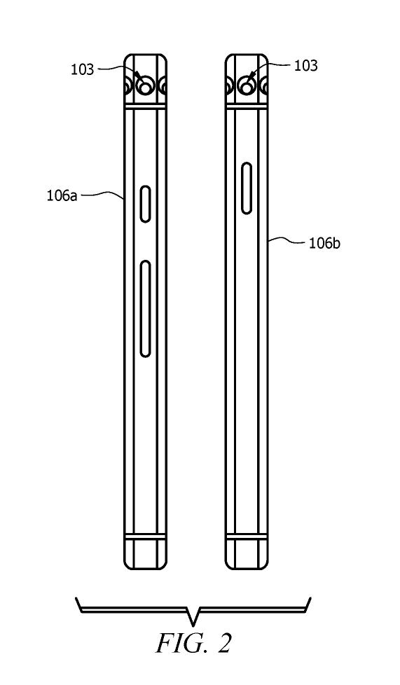

FIG. 2 is a left and right planar view of a mobile device with tandem lenses in one embodiment. As depicted both the left face 106a and the right face 106b comprise a single lens 103. As noted, if the mobile device was thicker, then the left 106a and right 106b faces can have more than one lens 103.

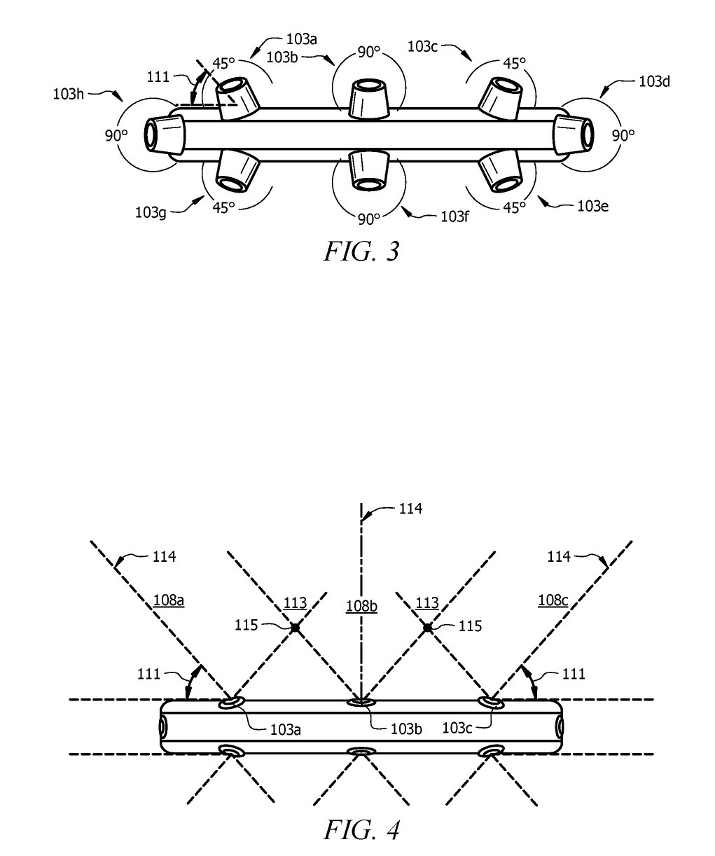

FIG. 3 is a top planar view of a mobile device with tandem lenses in one embodiment. As can be seen the mobile device depicted comprises eight tandem lenses 103a-h: three in the front face, three on the back face, and one each on the left side and right side.

As can be seen, some of the lenses comprise a straight lens whereas other lenses comprise an angled lens. A straight lens, as used herein, refers to a lens which is directed outward at approximately a ninety degree angle. As depicted the center lenses 103b,f and the side lenses 103h, d are straight lenses. Conversely, an angled lens is a lens which is angled relative to the planar face of the mobile device. An angled lens is a lens which is aimed at an angle other than a normal angle from the mobile device. As can be seen, the front left 103a, right 103c, and back left 103g and back right 103e comprise angled lenses. The remaining lenses are straight lenses.

The angled lens is pointed and angled at an angle 111 relative to the mobile device. The angle 111 can vary from between about 1 degree to about 89 degrees. In one embodiment the angle 111 is between 20 degrees to about 60 degrees. In one embodiment the angle 111 is approximately 45 degrees. It should be noted that while FIG. 3 shows the lenses 103 extending outward from the planar face of the mobile device, this is for illustrative purposes only and should not be deemed limiting. In other embodiments, for example, the lenses 103 are flush with the planar surface of the mobile device. In such embodiments the lenses 103 can still be angled because they are not aimed outward at a 90 degree angle.

The angle 111 can be adjusted depending upon the desired application. As the angle 111 of the front left lens 103 is decreased it points further away from the adjacent front center lens 103b. As the angle 111 of the front lens 103 is increased closer to 90 degrees, it points closer toward the adjacent front center lens 103b. The angle 111 directs the amount of overlap of captured images between adjacent lenses: when the angle 111 is decreased the amount of overlap is decreased as well.

Turning now to FIG. 4, FIG. 4 is a field of view profile of a mobile device in one embodiment. In the embodiment depicted the lenses 103 do not extend outward beyond the planar face of the mobile device but instead are flush with the mobile device. As can be seen, FIG. 4 shows the same mobile device with eight tandem lenses. For simplicity, FIG. 4 only shows the field of view 108a,b,c for the front lenses 103a, b, c. The size of the field of view 108 will adjust with the type of lenses. Thus, a wider lens will have a wider field of view and a narrower lens will have a narrow field of view. As shown, the left lens 103a is an angled lens whereas the middle lens 103b is a straight lens. Accordingly the field of view 108b for the middle lens 103b is aimed directly outward. Contrast this with the field of view 108a for the angled left lens 103a or the field of view 108c for the angled right lens 103c. As can be seen, the field of view 108a for the angled left lens 103a is tilted leftward. This results in the overlap 113 between adjacent lenses being decreased. If the left field of view 108a for the angled left lens 103 were tilted rightward, the overlap 113 would increase. As used herein, an overlap refers to the same portion of an image which is captured by more than one tandem lens. In one embodiment, as will be discussed in more detail below, decreasing the overlap results in faster processing and lower processing requirements as the software has less overlap to remove.

FIG. 4 also shows the aiming direction 114. The aiming direction 114 is the direction at which the lens is pointed. As seen, the middle straight lens 103b the aiming direction 114 is straight outward. Conversely, in the angled left lens 103a, the aiming direction 114 is angled outward relative to the direction 114 of the middle lens 103b. Likewise, the angled right lens 103c is aimed at a direction 114 outward relative to the direction 114 of the middle lens 103b. Having dissimilar aiming directions in adjacent lenses prevents the fishbowl effect which would otherwise result if the three tandem lenses each shared the same direction. Thus, in one embodiment at least two adjacent tandem lenses comprise dissimilar aiming directions.

FIG. 4 also depicts the intersection 115 of adjacent fields of views 108. Generally, if the field of views do not intersect until the edges, then distortion increases. This results in a fish bowl effect. Conversely, the closer the intersection 115 is relative to the mobile device, results in decreased distortion and fish bowl effect. Distortion on the horizontal axis results in stretching the rear or front images and wrapping around the sides. As can be seen, if the angle 111 is decreased, the intersection 115 point is further away from the mobile device than if the angle 111 is increased. Accordingly there is a balance: a smaller angle results in decreased overlap which requires decreased processing power but also results in perhaps, increased distortion. A larger angle will have increased overlap which can require additional processing power but can result in decreased distortion. Consequently, the angle 111 can be optimized over image quality, processing power, etc.

In one embodiment the lenses are fixed lenses meaning they remain in a stationary and fixed location. In such embodiments the angle 111 is static. In other embodiments, however, the lenses can move in one or more directions. As an example, the lenses can rotate, tilt, move up and down, left to right, etc. In such embodiments, the angle 111 can be adjusted depending upon the user's desired shot. In one embodiment the user controls the angle 111 whereas in other embodiments the mobile device optimizes the angle 111 and adjusts accordingly.

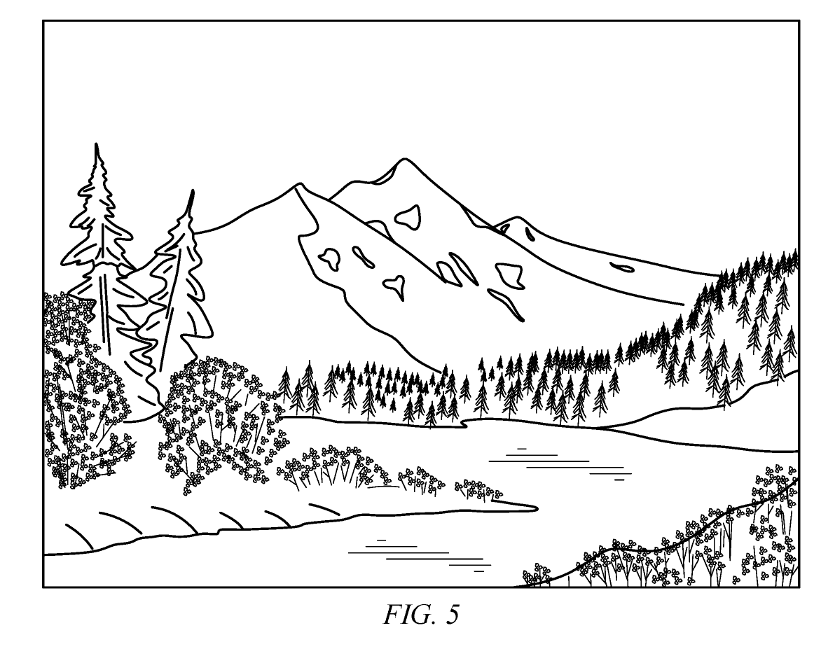

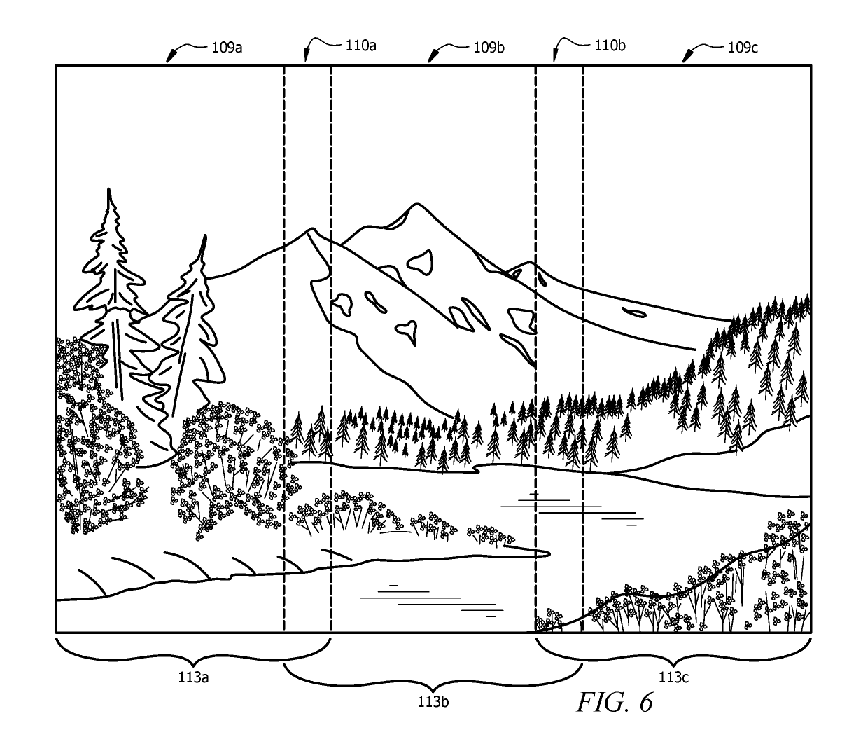

FIG. 5 depicts an image which a user sees and desires to capture. How that image is captured and processed is shown in FIG. 6. In FIG. 6 the left captured image 113a shows the image as it is captured by the left lens 103a. The middle captured image 113b shows the image as it is captured by the middle lens 103b. Likewise, the right captured image 113c shows the image as it is captured by the right lens 103c. The overlap image 110 refers to a portion of the image which is captured by more than one adjacent lens. As can be seen, the left captured image 113a only has one overlap image 110 whereas the middle captured image 113b comprises two overlap images 110. This is because, as shown in FIG. 4, the left lens 103a does not have an adjacent lens to its left; it only has an adjacent lens (lens 103b) on its right. Conversely, the middle lens 103b has an adjacent lens on its left (103a) and one on its right (103c). Consequently, the middle image 113b comprises two overlap images 110.

As previously noted, the angle 111 at which the angled lens is aimed controls the overlap 113 and consequently the overlap image 110. If the angle is decreased such that the left lens 103a, for example, is pointed further away from the middle lens 103b, then the resulting overlap image 110 will decrease. In one embodiment the overlap accounts for less than 25% of the total image. In another embodiment the overlap accounts for less than 10% of the total image. In still another embodiment the overlap accounts for less than 5% of the total image captured by a single lens.

If the left 113a, middle 113b, and right 113c images were laid side by side, the resulting image would not be the image depicted in FIG. 5. Rather, the image would have the overlap image 110 duplicated. Consequently, to obtain the desired image as shown in FIG. 5, the system must stitch the images together and remove a redundant overlap image 110. This will be addressed below, however, in one embodiment reducing the size and quantity of the overlap image 110 reduces the process load required as comparatively less redundant images have to be removed.

While FIG. 6 only depicts three captured images from three adjacent tandem lenses, this is for illustration purposes only and should not be deemed limiting. The same explanation holds true for additional lenses. For example, a 360 degree photograph would be captured in the same fashion described above.

Now that the mobile device 100 comprising at least two tandem lenses 103 has been described, a method of using the device will be described. The discussion will center on the mobile device depicted in FIG. 3, but as noted, this is for illustrative purposes only and should not be deemed limiting.

First the user will position the mobile device 100 in the desired location. Next, the user will select the desired format including still photographs, video, panoramic, etc. Thereafter, the user initiates the camera to record the image. In one embodiment all lenses 103 record in unison to capture the desired image. Thus, in one embodiment each lens 103 will snap and record an image.

In one embodiment the user will be presented one or more images corresponding to one or more lenses. For example, considering the mobile device in FIG. 3, in one embodiment the user will be presented with a single image from each of the lenses. In one embodiment the user will further be presented with a 360 degree image. The user can select one, or a plurality of lenses, to capture the desired image. Thus, in some embodiments the user may select simply the front three lenses, whereas in other embodiments the user may select the back three lenses.

In one embodiment at least one light source 102 will flash. As can be appreciated with the device shown in FIG. 3, perhaps the front face of the device will require a flash but the back face of the device, which has more exposed sunlight in this example, will not require a flash. Thus, in one embodiment the mobile device determines which light source 102, if any, needs to flash to capture the image. As noted, if the front face is facing an object under a shade tree whereas the back face is facing an object in direct sun, then only the front face light source 102 will flash.

As noted, this system allows a wide image to be captured without the need to rotate the mobile device. This is a tremendous advantage because the images are taken simultaneously. As such, the fear that the user will not maintain a steady image while rotating the mobile device is eliminated. Previously, if the use had a single lens and rotated the mobile device, the image could be blurry if the user was not steady. Thus, if the user shook or had an unsteady hand, the image was blurry. Likewise, if the user was moving the mobile device to obtain a panoramic or 360 degree picture, the user had to maintain the mobile device at the exact same elevation. If the user moved the mobile device upwards or downwards, then the image would not align. However, because the user simultaneously uses lenses 103 in tandem, these concerns are eliminated. The user can hold the mobile device and take a picture without fear of shaking or moving because the image is captured simultaneously.

Because a mobile device can capture a wide angle image or video without rotating the mobile device, the image or video can be captured faster and more efficiently than previously available. Additionally, because all sides, in one embodiment, can be captured, the user does not run the risk of missing something. For example, if a user is having to rotate the phone in a wide circle to capture a 360 degree image, then the user is necessarily missing movement or action when the single lens is not focusing on an object. If the single lens is facing forward, for example, it could miss an event, smile, etc. which happens on the back side which does not have a lens. Conversely, in embodiments wherein all sides have a lens working in tandem, all of the action is recorded. Thus, the user will not fail to record something in the back while facing forward, which is common in the prior art.

Another benefit is taking pictures of a group of people. Previously where the user had to start forward and then rotate in a circle, the people had to be directed to smile when the camera was facing in their direction. Thus the user would have to instruct everyone to wait to smile until the camera was facing them. Taking a picture in this fashion could often take five seconds or more. However, with the lenses working in tandem, everyone can smile at the same time, and the photograph is taken in an instant.

As noted, the system and method disclosed herein can be used to capture images as well as video. Thus, a user can hold the mobile device, initiate recording, and the lenses 103 will work in tandem to record a wide angle video. In one embodiment the lenses 103 will create a 360 degree video. In one embodiment the mobile device also captures and records sound.

As noted, in one embodiment the lenses 103 connect to software which can compile the images from the various lenses 103 in a desired format. As noted, the software can prioritize certain lenses 103 over others. The software can be used to eliminate the overlap between adjacent lenses 103 so that the resulting image looks continuous. Further, as noted, the software can determine which light source 102, if any, is needed for a particular lens 103.

In one embodiment the software calculates the similarities in adjacent pixels to determine which overlap image should be used. This allows for the creation of a seamless final photograph or video which is really compiled from a series of adjacent photographs or videos.

As can be seen, the system and method discussed herein offers a plurality of benefits when compared to the prior art. As noted, the tandem lenses 103 can be built directly into a mobile device such as a mobile phone. In still other embodiments an attachment can comprise the tandem lenses 103, and the attachment can communicate with other devices such as a mobile device or a computer. This allows users who do not have a smart phone, for example, which has tandem lenses 103, to still obtain the benefit by connecting to an attachment.

As noted, in one embodiment the tandem lenses are sufficiently compact to be stored or housed on a mobile device such as a mobile phone. In one embodiment the mobile device comprising tandem lenses can fit within a front pocket. This is an advantage compared to the prior art which utilized large and bulky cameras in an attempt to obtain a 360 degree image. Because the mobile device, and the tandem lenses, are stored as a single unit, in some embodiments, the device is easy to manipulate, store, and use.

In one embodiment the tandem lenses 103 can be used to record images and video for virtual reality. For example, in one embodiment at least one lens comprises a sensor to provide for augmented virtual reality. In one embodiment the system can be used with third-party applications such as Facebook, Instagram, Twitter, Periscope, Youtube, etc. Such applications will be able to utilize the system incorporating the tandem lenses 103 to allow for 360 degree live streaming or recording. Accordingly, often with a single click, users will be able to seamlessly stich all images from multiple tandem lenses 103 into a full final image or video.

As noted, in one embodiment the system comprises one or more angled lenses. An angled lens allows the overlap image to be decreased. Because software must remove redundancies in an overlap image, decreased the overlap image decreases the processing load of the software. This allows images to be processed in much faster times requiring less processing power than if the overlap were not decreased. Additionally, having a plurality of adjacent lenses, some being angled, reduces the fishbowl effect which can result from increased overlap.

Those with skill in the art will understand the capability of modifying the power and type of each lens 103. In one embodiment each lens 103 comprises an 8 megapixel camera.

While the invention has been particularly shown and described with reference to a preferred embodiment, it will be understood by those skilled in the art that various changes in form and detail may be made therein without departing from the spirit and scope of the invention.

### Additional Description

The following clauses are offered as further description of the disclosed invention.
Clause 1. A system for capturing images, said system comprising:
   a mobile device which comprises at least two tandem lenses;
   wherein each tandem lens works together to create a final image.
Clause 2. The system of any proceeding or preceding clause wherein said mobile device comprises a smart phone.
Clause 3. The system of any proceeding or preceding clause wherein said mobile device comprises a camera.
Clause 4. The system of any proceeding or preceding clause wherein said mobile device comprises at least two opposing faces, and wherein at least one tandem lens is on each opposing face.
Clause 5. The system of any proceeding or preceding clause wherein each of said at least two opposing faces comprises a plurality of tandem lenses.
Clause 6. The system of any proceeding or preceding clause wherein said mobile device comprises a light source.
Clause 7. The system of any proceeding or preceding clause wherein one of said lenses comprises a straight lens and one of said lenses comprise an angled lens.
Clause 8. The system of any proceeding or preceding clause wherein said angled lens is angled between 20 and 60 degrees relative to a planar face of said mobile device.
Clause 9. The system of any proceeding or preceding clause wherein said mobile device comprises at least two opposing faces coupled via two sides, wherein a first face comprises three lenses, wherein a second face comprises three lenses.
Clause 10. The system of any proceeding or preceding clause wherein said two sides each comprise one lens.
Clause 11. The system of any proceeding or preceding clause wherein said first face comprises a middle straight lens and two angled lenses.
Clause 12. The system of any proceeding or preceding clause wherein one of said angled lenses is fixed.
Clause 13. The system of any proceeding or preceding clause wherein one of said angled lenses is adjustable.
Clause 14. An apparatus for capturing images, said apparatus comprising:
   a mobile device which comprises at least two tandem lenses;
   wherein said mobile device comprises at least two opposing faces, and wherein at least one tandem lens is on each opposing face;
   wherein one of said lenses comprises a straight lens and one of said lenses comprise an angled lens; and
   wherein said angled lens is angled between 20 and 60 degrees relative to a planar face of said mobile device.
Clause 15. The apparatus of any proceeding or preceding clause wherein each tandem lens works together to create a final image.
Clause 16. The apparatus of any proceeding or preceding clause wherein one of said angled lenses is fixed.
Clause 17. The apparatus of any proceeding or preceding clause wherein one of said angled lenses is adjustable.

What is claimed is:

1. A system for capturing images, said system comprising:
a mobile device which comprises at least two tandem lenses;
wherein each tandem lens works together to create a final image.

2. The system of claim 1 wherein said mobile device comprises a smart phone.

3. The system of claim 1 wherein said mobile device comprises a camera.

4. The system of claim 1 wherein said mobile device comprises at least two opposing faces, and wherein at least one tandem lens is on each opposing face.

5. The system of claim 1 wherein each of said at least two opposing faces comprises a plurality of tandem lenses.

6. The system of claim 1 wherein said mobile device comprises a light source.

7. The system of claim 1 wherein one of said lenses comprises a straight lens and one of said lenses comprise an angled lens.

8. The system of claim 7 wherein said angled lens is angled between 20 and 60 degrees relative to a planar face of said mobile device.

9. The system of claim 1 wherein said mobile device comprises at least two opposing faces coupled via two sides, wherein a first face comprises three lenses, wherein a second face comprises three lenses.

10. The system of claim 9 wherein said two sides each comprise one lens.

11. The system of claim 9 wherein said first face comprises a middle straight lens and two angled lenses.

12. The system of claim 11 wherein one of said angled lenses is fixed.

13. The system of claim 11 wherein one of said angled lenses is adjustable.

14. An apparatus for capturing images, said apparatus comprising:
a mobile device which comprises at least two tandem lenses;
wherein said mobile device comprises at least two opposing faces, and wherein at least one tandem lens is on each opposing face;
wherein one of said lenses comprises a straight lens and one of said lenses comprise an angled lens; and
wherein said angled lens is angled between 20 and 60 degrees relative to a planar face of said mobile device.

15. The apparatus of claim 14 wherein each tandem lens works together to create a final image.

16. The apparatus of claim 14 wherein one of said angled lenses is fixed.

17. The apparatus of claim 14 wherein one of said angled lenses is adjustable.
